(19) United States
(12) Patent Application Publication
(10) Pub. No.: US 2009/0090039 A1
(43) Pub. Date: Apr. 9, 2009

(54) Quick connect-disconnect fish hook coupling system

(76) Inventor: Larry Ross, Huntsville (CA)

Correspondence Address: Nields, Lemack & Frame, LLC, 176 E. Main Street, Suite #5, Westborough, MA, 01581, US

(21) Appl. No.: 11/906,638

(22) Filed: Oct. 3, 2007

(51) Int. Cl. A01K 83/00; A01K 85/00

(52) U.S. Cl. 43/42.09; 43/44.82; 43/44.83

(57) ABSTRACT

A quick-connect-disconnect fish hook coupling system is provided. The system uses a fish hook having a solid ball-shaped head and a hollow-bodied coupler that releasably retains the ball-shaped head of the hook. The hook can swing freely while retained.

### FIELD OF THE INVENTION

The invention relates to hooks and lures for fishing, and more particularly, relates to methods of coupling fish hooks and lures.

### BACKGROUND OF THE INVENTION

Fishing continues to be a very popular sport. Fishermen enjoy the challenge of outwitting fish—and lure technology has become very sophisticated.

However, there is an area of fishing technology that has not benefited from the rising sophistication. Fishing lures are not very modular—and do not allow easy adaptation from one hook to another.

Fishing lures are typically purchased, utilized and stored by fishermen with a hook or hooks attached. However, for various reasons, a fisherman might want to change hooks on a lure. Hooks may dull or break in use and require sharpening or replacement. Lures are often supplied with inferior quality hooks. The hook points on these hooks are often dull and will not “hold” a sharpening as long as higher quality hooks will. As a result, a fisherman may want to remove hooks supplied with a lure to replace them with higher quality (and more expensive) hooks that are purchased individually.

A fisherman may desire to switch a hook for one of higher quality or one having a different configuration. For example, he may want to swap the hook for a red hook. A recent popular trend is the use of hooks that are painted red. Many lures are now shipped and sold with red hooks attached. The theory is that the red hooks themselves attract fish (perhaps because they look like blood in the water) and encourage the fish to bite the lure. In addition, the red hooks tend to be higher quality and have very sharp points as compared to most available hooks.

There is also a trend to the use of barbless hooks (mandatory in some fishing areas). Conservation and “catch and release” fishing is becoming very popular in the fishing community. The barb on the hook helps to ensure that fish have a more difficult time disengaging themselves from the hook but it also makes it much more difficult to release the fish once landed. Disengaging a barbed hook from a fish often results in tearing of the fish's mouth which may result in a higher mortality rate among released fish. The use of barbless hooks allows the fisherman to easily remove the hook and release the fish without harming it. In many jurisdictions, barbless (and often single barbless) hooks are mandatory.

With existing mechanisms, removing or switching hooks for any of these reasons is not an easy matter.

The hooks are typically attached to the lure through the use of a “split ring” connector. A split ring is similar to a key ring, only considerably smaller (usually on the order of about 2-5 mm in diameter). By manually “splitting” the overlapping sides of the split ring (for example, with one's fingernail or finger tip), the top end of the hook (which has a loop or an eye) can be slid onto an outer end of the split ring. The hook is then slid inwardly along the ring until it passes over the inner end of the ring. At that point, the hook is attached to the split ring. To remove the hook, the process is reversed. The split ring remains attached to the lure. Changing hooks with this type of connector is very difficult and time consuming and, as a result, most fishermen are reluctant to change hooks, especially in the field. The split rings are typically very small, requiring a high level of finger strength and dexterity. This may be particularly challenging with cold or wet hands, and impossible while wearing gloves.

Split rings also make it difficult to remove a hook to store it separately from the lure body. For practical purposes, the only time that hooks need be attached to the lure is when the lure is actually being used for fishing. At other times having the hooks attached to the lure is actually a detriment. In close proximity to each other when stored in a tackle box, the attached hooks on the lures become tangled making it difficult for the fisherman to select and extract one particular lure from the tackle box for use. The attached hook points will also quickly become dull as they collide with adjacent lures and other hooks.

Having the hooks attached to the lures in storage can also pose a physical danger. In selecting and handling lures, the fisherman can get cut or pricked by the hooks (in some cases causing embedment of the hook). This is a particular concern for children, who may not be as careful or attentive in handling the lures as adults.

It would be desirable to provide a fish hook coupling system that allows for quick connection and disconnection of the fish hook to avoid the aforementioned difficulties.

### SUMMARY OF THE INVENTION

According to a first aspect of the invention, a fish hook is provided. The fish hook body has a solid head and a shaft. There is at least one hook opposite the head. The head preferably has a flattened ball shape. The fish hook may have any number of hooks attached. In one version, a “treble” hook is provided, having three hooks attached to a common shaft.

According to a second aspect of the invention, a quick-connect-disconnect fish hook coupling system is provided. A fish hook is provided with a solid ball-shaped head. A hollow body coupler with an interior channel is also provided. The coupler body has a substantially closed retaining end and a cup end with a small opening. A relatively larger side access opening is also defined in the body, and a narrow slot extends from the side access opening to the opening in the cup end. The side access opening is sized to allow insertion of the ball-shaped head of the hook into the interior channel whereupon the hook can be pulled by the shaft through the slot to seat the ball-shaped head in the channel at the cup end. The channel has a retainer to releasably retain the ball-shaped head in the cup end. The coupling system allows the hook to extend out of the small opening in the coupler body where it can swing freely while retained. At the closed retaining end, an attachment means may be provided for connection to a lure. The fish hook may be coloured. Attractants may be provided (pre-baited) with the fish hook, such as worm- or minnow-type baits.

Various configurations of the coupling system are possible. The coupler may be used to attach a hook to a body bait lure. Alternatively, the coupler may be used to attach a hook to a spinner lure. Alternatively, the coupler may be used to attach a hook to a spoon type lure.

The retainer may be a spring. For example, a strip of spring steel may be used or a filament may be used to bias the ball-shaped end of the fish hook into releasable engagement when the fish hook is seated in the cup end.

According to a third aspect of the invention, a quick-connect-disconnect coupler is provided. The coupler permits a ball-headed fish hook to be coupled to a fishing lure. The coupler has a hollow body, defining an interior channel. The body has a substantially closed retaining end for attachment to the lure and a cup end. The cup end has a small opening. A relatively larger side access opening is also defined in the body, and there is a narrow slot extending from the side access opening to the opening in the cup end. The side access opening is sized to allow insertion of the hook into the interior channel. The hook can be pulled through the slot to seat in the channel at the cup end. The channel has a retainer to releasably retain the hook in the cup end. The coupler allows the hook to extend out of the small opening at the cup end where it can swing freely while retained. Various configurations of coupler are possible. The coupler may be provided with additional accessories to attract fish. An attractant (such as a scented bait) may be positioned within the channel. The attractant may be retained in the channel, or it may be loosely confined. The attractant (or another accessory) may be inserted into the channel via the side access opening.

According to a fourth aspect of the invention, a quick-connect-disconnect coupling lure is provided. The lure has a fishing lure body. On the body is a hollow coupler extension that defines an interior channel. The coupler extension has a substantially closed retaining end for attachment to the lure and a cup end. The cup end has a small opening. There is also a relatively larger side access opening defined in the coupler extension. A narrow slot extends from the side access opening to the opening in the cup end. The side access opening is sized to allow insertion of the hook into the interior channel. The hook can be pulled through the slot to seat in the channel at the cup end. The channel has a retainer to releasably retain the hook in the cup end. The coupler extension allows the hook to extend out of the small opening where it can swing freely away from the lure body while retained. The lure may have one or a plurality of coupler extensions.

### BRIEF DESCRIPTION OF THE DRAWINGS

FIG. 1 is a perspective view of a first embodiment of the quick-connect-disconnect fish hook coupling system (body bait type).

FIG. 2A is a perspective view of a treble hook according to the present invention.

FIG. 2B is a perspective view of a single hook according to the present invention.

FIG. 3A is a side view (in partial cutaway) of the coupler of the first embodiment of the quick-connect-disconnect fish hook coupling system.

FIG. 3B is an end view of the coupler of the first embodiment.

FIG. 4A is a front view of a second embodiment of the quick-connect-disconnect fish hook coupling system (weighted spinner type).

FIG. 4B is a front view (in partial cutaway) of the coupler of the second embodiment of the quick-connect-disconnect fish hook coupling system.

FIG. 5A is a front view of a third embodiment of the quick-connect-disconnect fish hook coupling system (spoon type).

FIG. 5B is an exploded (assembly) view of the third embodiment.

FIG. 5C is a front view (in partial cutaway) of the coupler of the third embodiment.

### DETAILED DESCRIPTION

The Figures illustrate several possible embodiments of the invention. Modular hooks and various types of lures are provided, in assembly and separate.

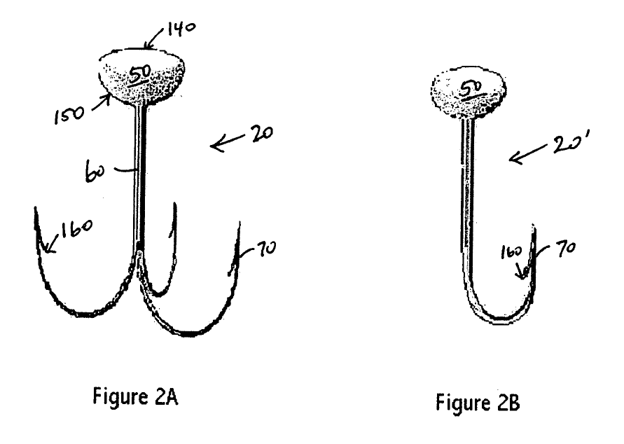

A central component of the invention is an improved form of fish hook. Two examples are shown in FIGS. 2A and 2B. FIG. 2A shows a treble hook 20. FIG. 2B shows a single hook variant 20′. In both hook styles, the head 50 of the hook is generally ball-shaped. The hook has a shaft 60 and hooked points or ends 70 (with or without barbs 160 on the ends).

Preferably, as shown in FIGS. 2A and 2B, the ball head is slightly rounded on the bottom 150 and slightly flattened on the top 140. This rounded bottom surface 150 allows free swinging movement of the fish hook when retained in a cup-shaped holder. The slightly flattened top surface 140 provides a stable surface for gripping with a retaining spring. The lower profile of the ball head also is believed to reduce drag in the water. The shaft 60 of the hook may also be slightly longer than a traditional hook to allow for the fact that the hook will attach slightly higher than a traditional hook.

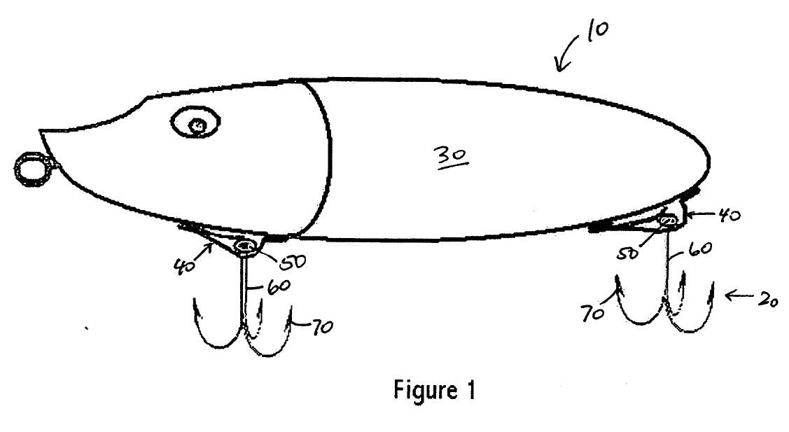

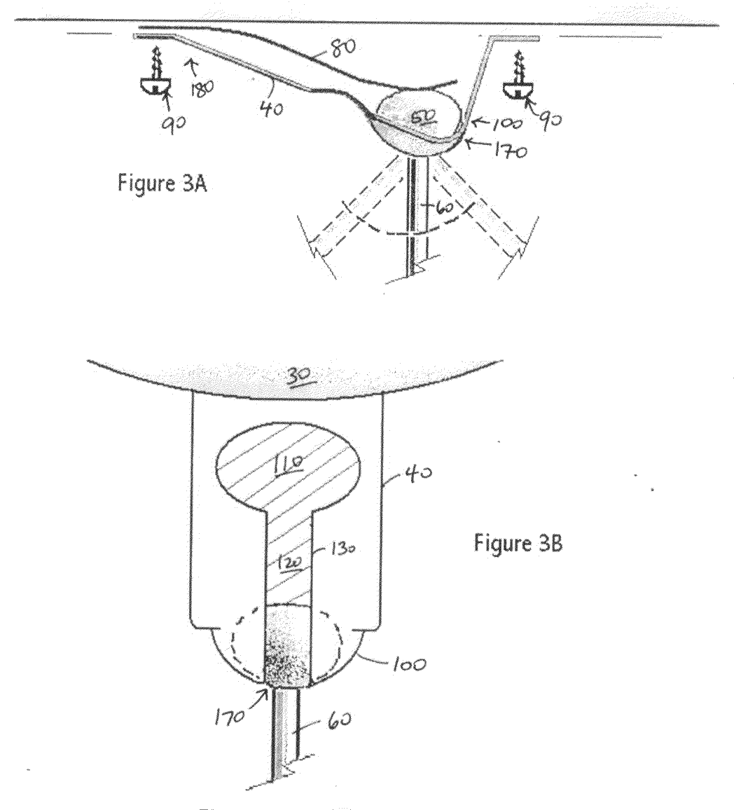

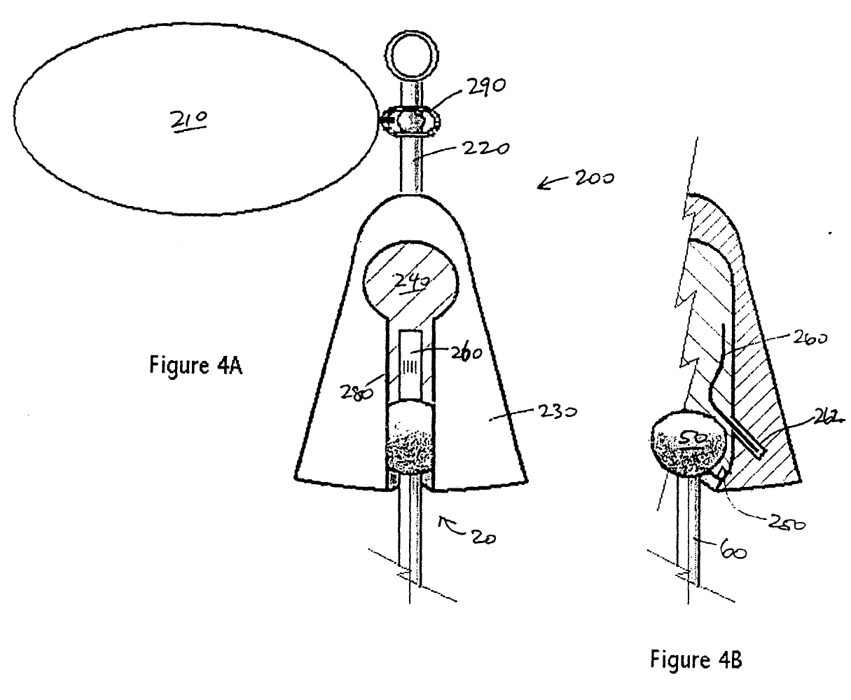

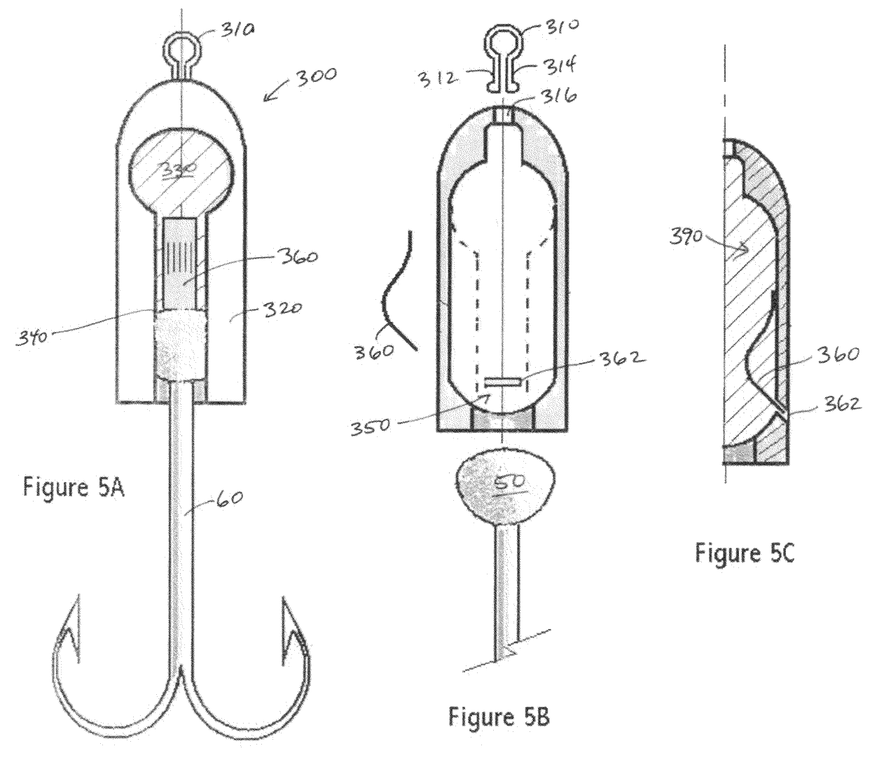

A coupler is used to connect the improved hook to a lure. The coupler may be part of the lure assembly (as in the weighted spinner embodiment shown in FIGS. 4A and 4B). The coupler may be an extension of the lure (as in the embodiment shown in FIG. 1—with greater detail in FIGS. 3A and 3B). Alternatively, the coupler may be a separate piece that is used between the lure component and the hook (as in the “spoon type” embodiment shown in FIGS. 5A-5C).

The coupler is said to be a “quick-connect-disconnect” coupler as the ball-shaped head 50 of the hook 20 simply slides into an opening in the coupler, and is releasably retained in the coupler by its ball-shaped head. The ball shape allows the hook to swing freely even while retained in the coupler. The hook also easily disconnects from the coupler by sliding the ball-shaped head back toward the opening where it can be removed. The fisherman does not need to grasp any portion of the hook with his fingers. The process can be carried out with pliers or while wearing gloves.

FIG. 1 shows an assembly 10 having a “body bait” lure 30 with hooks attached to couplers 40 that extend from the body of the lure 30. As shown, when the hooks 20 are connected to the lure by the coupler extensions 40, the shaft 60 and point 70 parts of the hooks hang freely, depending from the ball-shaped heads 50 of the hooks 20. A possible configuration with two treble hooks 20 attached at two coupler extensions 40 is shown. However, it will be appreciated that one or any number of coupler extensions may be provided. Also, hooks of different configurations (with single or multiple hook ends) and sizes may be used.

FIGS. 3A and 3B show more detail of the “body bait” type coupler. As shown in FIG. 3A (side view), the coupler extension 40 has a closed retaining end 180 and a generally cup-shaped end 100. The coupler extension may be attached to the body of the lure 30 by any attachment method. As one example, the coupler extension 40 may be attached by screws 90 to the body of the lure. The hook is shown lodged at the cup end 100 of the coupler where the ball-shaped head 50 is nestled securely, but the shaft 60 extends out of the coupler at opening 170 and is allowed to swing freely away from the body. As shown, retainer 80 (here, a small strip of spring steel) holds the head of the hook to prevent unwanted up-down movement of the hook in the coupler 40. FIG. 3B shows an end view of the coupler looking from the front of the lure. The head of the hook is inserted into the opening 110 shown in FIG. 3B and slid in the hollow chamber 120 of the coupler along the slot 130 (cut shaft) toward the back of the lure until it drops into the cup end 100 of the coupler. The retainer spring 80 exerts enough pressure to ensure that the hook does not pop up during normal use. The retainer spring 80 preferably grips the flattened top surface 140 of the ball head of the hook.

When a fish bites and is attached to the hook, it is unable to disengage the hook from the lure for two reasons:
1. The downward pressure of the retainer spring will not allow the hook to pop up.
2. The fish does not have hands. As the fish twists and turns it cannot exert up ward pressure on the hook as it is akin to pushing on a rope. Only when the body of the lure is held securely, allowing upward pressure to be exerted on the hook, can the hook be disengaged from the coupler. Only the fisherman can perform this task.

Once the fisherman is finished with the lure 30, the hook 20 may be easily and quickly detached. To disconnect the hook, the fisherman holds onto the body of the lure with one hand, pushes the hook up, sliding it towards the front of the lure and out the opening 110.

Opening 170 at the cup end 110 is smaller than the “side access” opening 110. When the hook is attached, it may swivel freely as the opening 170 in the cup end of the coupler is larger than the shaft 60 of the hook yet smaller than the ball-shaped head 50 of the hook.

FIGS. 4A and 4B show an assembly 200 having a coupler 230 for a “weighted spinner” type of lure. Spinner blade 210 spins on shaft 220 via spinner blade connector 290. Coupler 230 is preferably weighted. Similar to the “body bait” type of coupler, to attach the hook, the head 50 of the hook is inserted into a side access opening 240 and slid down via slot 280 into a cup end 250 of the coupler. Detail on the retainer spring 260 is shown in FIG. 4B. Retainer spring 260 is retained in retainer spring slot 262. The spring bears on the top surface of the hook head 50 (as shown in FIG. 4B) to retain the hook 20 against upward movement in the coupler 230.

FIGS. 5A-5C show an assembly 300 having a coupler 320 for a “spoon” type of lure, or another lure where it is impractical to incorporate the coupler into the lure itself. The coupler 320 would be connected to the lure (such as a spoon) via connector ring 310. The connector ring 310 is preferably made of spring steel. At rest, legs 312, 314 are slightly biased apart. When legs 312, 314 are flexed together, the connector can be inserted in or removed from neck 316 of coupler 320. The connector ring 310 allows the coupler to be connected to a spoon or another type of lure, or the connector ring may be directly attached to a fishing line (not shown). As in the other embodiments described above, to attach the hook, the head 50 of the hook is inserted into a side access opening 330 and slid down via slot 340 into a cup end 350 of the hollow chamber 390 of the coupler 320. A retainer spring 360 releasably retains the head 50 of the hook in place. Retainer spring 360 is retained in retainer spring slot 362, as shown in FIG. 5C.

In all of the above embodiments, it will be appreciated that other baits or attractants may be additionally coupled to the hook (such as live or artificial worms, minnows, etc.).

The couplers of the above embodiments may be constructed of any suitable material or materials. Rust-proof metal (or coated metal), plastic, or nylon are some possible choices. The materials should be able to withstand wide temperature variation, freezing and thawing, extended immersion in water, and exposure to the elements (e.g. UV stable plastics and paint coatings may be preferred).

To manufacture the couplers, molding or stamping/forming processes may be used as are well-known in the art. Apart from the retainer spring, which is preferably a separate element, it is believed that the coupler could be manufactured as a unitary piece.

Because of the modularity of the present invention, various manufacturing and sales options exist. A fisherman could purchase a kit (or collect components separately) to include hooks of various sizes and colours. The fishing lures could be manufactured and shipped without hooks (saving production complexity and cost). Fishermen could also purchase and store the hookless lures avoiding the problems associated with safety, lures tangling and hooks becoming dull in storage.

In the hook kit (not shown), the various hooks could be stored separately from each other to avoid hook collisions that would dull the points. When the hook points become dull through normal use they could be sharpened or the hook could be easily disposed of and a new hook purchased. Thus, a fisherman could purchase and maintain a very small number of hooks, yet get a better lifespan of use out of each hook due to the improved storage conditions.

Separate storage of hooks also allows for easy selection and installation of hooks in the field and according to the whim of the fisherman. When a lure is selected for use the proper size hook would be selected from the hook kit and easily attached to the lure. The lure would be used for fishing and afterward the hook could be easily detached and stored in the hook kit and the lure stored separately.

Hooks may also be “dressed up” with the addition of other materials such as imitation deer hair skirts, beads etc that also serve to make the hooks attractive to fish. Allowing for the quick connection of hooks with these additions will give the fisherman flexibility and will increase the likelihood of attracting and catching fish.

The hollow chamber of the coupler also raises other options. For example, the chamber could be used to hold other attractants such as scented components. A small sleeve containing a small piece of sponge or other permeable material could be threaded onto the shaft of the hook prior to attachment to the lure. Scent may then be added to the permeable sponge and will disperse slowly over time increasing the effectiveness of adding scent to the lures.

This invention will greatly enhance the enjoyment and safety of the fishing experience. The various components of the system are simple, inexpensive to manufacture and will not interfere with the normal use of the lure. The ability to quickly change hooks will allow for flexibility in the field and increase the confidence and ultimately the success for the fisherman.

While the foregoing is directed to embodiments of the present invention, other and further embodiments of the invention may be devised without departing from the basic scope thereof, and the scope thereof is determined by the claims that follow.

What is claimed is:

1. A fish hook, comprising:
a fish hook body having a solid head, at least one hook opposite the head, and a shaft therebetween, wherein the head has a flattened ball shape.

2. The fish hook of claim 1, wherein the at least one hook comprises three hooks.

3. A quick-connect-disconnect fish hook coupling system, comprising:
a fish hook having a solid ball-shaped head, at least one hook opposite the head, and a shaft therebetween; and
a coupler having a hollow body, defining an interior channel, the body having a substantially closed retaining end and a cup end, the cup end having a small opening, a relatively larger side access opening being defined in the body, a narrow slot extending from the side access opening to the opening in the cup end, the side access opening being sized to allow insertion of the ball-shaped head of the hook into the interior channel whereupon the hook can be pulled by the shaft through the slot to seat the ball-shaped head in the channel at the cup end, the channel having a retainer to releasably retain the ball-shaped head in the cup end, such that the hook extends out of the small opening and can swing freely while retained.

4. The quick-connect-disconnect fish hook coupling system of claim 3, wherein the coupler is attached to a body bait lure.

5. The quick-connect-disconnect fish hook coupling system of claim 3, wherein the coupler is attached to a spinner lure.

6. The quick-connect-disconnect fish hook coupling system of claim 3, wherein the coupler is attached to a spoon type lure.

7. The quick-connect-disconnect fish hook coupling system of claim 3, wherein the coupler includes an attachment means at the closed retaining end for connection to a lure.

8. The quick-connect-disconnect fish hook coupling system of claim 3, wherein the retainer is a spring.

9. The quick-connect-disconnect fish hook coupling system of claim 3, wherein the retainer is a spring steel strip or filament biased to releasably engage the ball-shaped end of the fish hook when the fish hook is seated in the cup end.

10. The quick-connect-disconnect fish hook coupling system of claim 3, wherein the fish hook comprises a coloured fish hook.

11. The quick-connect-disconnect fish hook coupling system of claim 3, wherein the fish hook is pre-baited with an attractant.

12. The quick-connect-disconnect fish hook coupling system of claim 11, wherein the attractant is a worm- or minnow-type bait.

13. A quick-connect-disconnect coupler for coupling a ball-headed fish hook to a fishing lure, comprising:
a hollow coupler body, defining an interior channel, the body having a substantially closed retaining end for attachment to the lure and a cup end, the cup end having a small opening, a relatively larger side access opening being defined in the body, a narrow slot extending from the side access opening to the opening in the cup end, the side access opening being sized to allow insertion of the hook into the interior channel whereupon the hook can be pulled through the slot to seat in the channel at the cup end, the channel having a retainer to releasably retain the hook in the cup end, adapted to allow the hook to extend out of the small opening where it can swing freely while retained.

14. The quick-connect-disconnect coupler of claim 13, further comprising an attractant positioned within the channel.

15. The quick-connect-disconnect coupler of claim 14, wherein the attractant is retained in the channel.

16. The quick-connect-disconnect coupler of claim 13, wherein the channel is sized to receive an attractant or accessory, insertable into the channel via the side access opening.

17. A quick-connect-disconnect coupling lure for coupling to a ball-headed fish hook, the lure comprising:
a fishing lure body having a hollow coupler extension defining an interior channel, the coupler extension having a substantially closed retaining end for attachment to the lure and a cup end, the cup end having a small opening, a relatively larger side access opening being defined in the coupler extension, a narrow slot extending from the side access opening to the opening in the cup end, the side access opening being sized to allow insertion of the hook into the interior channel whereupon the hook can be pulled through the slot to seat in the channel at the cup end, the channel having a retainer to releasably retain the hook in the cup end, adapted to allow the hook to extend out of the small opening where it can swing freely away from the lure body while retained.

18. The quick-connect-disconnect coupling lure of claim 17, wherein the lure has a plurality of coupler extensions.
